(19) United States
(12) Patent Application Publication
(10) Pub. No.: US 2024/0368768 A1
(43) Pub. Date: Nov. 7, 2024

(54) METHOD FOR PREVENTING CORROSION TO AN IRON ALLOY POST

(71) Applicant: Phillip Leadbeatter, Torquay (AU)

(72) Inventor: Phillip Leadbeatter, Torquay (AU)

(21) Appl. No.: 18/142,646

(22) Filed: May 3, 2023

(51) Int. Cl. C23F 11/00; B29C 63/00; B29C 63/18; B29C 63/48; E04H 17/22

(52) U.S. Cl. CPC C23F 11/00; B29C 63/0069; B29C 63/18; B29C 63/486; E04H 17/22; B29C 2063/483; B29L 2031/73

(57) ABSTRACT

A method for preventing corrosion to an iron alloy post for enclosing an exterior surface of a galvanized fence post with insulation to reduce deterioration due to oxidation includes the steps of coating a fence post with an anti-corrosion solution to prevent corrosion to the fence post due to oxidation. The fence post extends into an insulation sleeve such that the exterior surface of the fence post is completely enclosed within the insulation sleeve. A standing member fastens to the fence post and is positioned adjacent to a bottom end of the fence post. The bottom end and the standing member insert into a ground surface to frictionally anchor the fence post in ground surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to methods for preventing corrosion and more particularly pertains to a new method for preventing corrosion for enclosing an exterior surface of a galvanized fence post with insulation to reduce deterioration due to oxidation.

### (2) Description of Related Art Including Information Disclosed Under 37 CFR 1.97 and 1.98

The prior art relates to methods for preventing corrosion teaches a variety of methods including coating the iron alloy material with an anti-corrosive solution to prevent deterioration due to oxidation. Known prior art does not teach insulating a coated iron alloy fence post with a sleeve and attaching a stand member thereto that anchors the fence post within a ground surface.

### BRIEF SUMMARY OF THE INVENTION

An embodiment of the disclosure meets the needs presented above by generally comprising a method including the steps of coating a fence post with an anti-corrosion solution configured to prevent corrosion to the fence post due to oxidation. The fence post extends into an insulation sleeve such that the exterior surface of the fence post is completely enclosed within the insulation sleeve. A standing member fastens to the fence post and is positioned adjacent to a bottom end of the fence post. The bottom end and the standing member insert into a ground surface to frictionally anchor the fence post in ground surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a method for preventing corrosion to an iron alloy post according to an embodiment of the disclosure.

FIG. 2 is a detail in-use view of an embodiment of the disclosure.

FIG. 3 is a detail isometric view of an embodiment of the disclosure.

FIG. 4 is a detail in-use view of an embodiment of the disclosure.

FIG. 5 is a detail isometric view of an embodiment of the disclosure.

FIG. 6 is a cross-sectional view of an embodiment of the disclosure taken along Line 6-6 of FIG. 5.

FIG. 7 is a detail view of an embodiment of the disclosure taken from Magnified Circle 7 of FIG. 6

FIG. 8 is a detail isometric view of an embodiment of the disclosure.

FIG. 9 is an in-use view of an embodiment of the disclosure.

FIG. 10 is an in-use view of an embodiment of the disclosure.

### DETAILED DESCRIPTION OF THE INVENTION

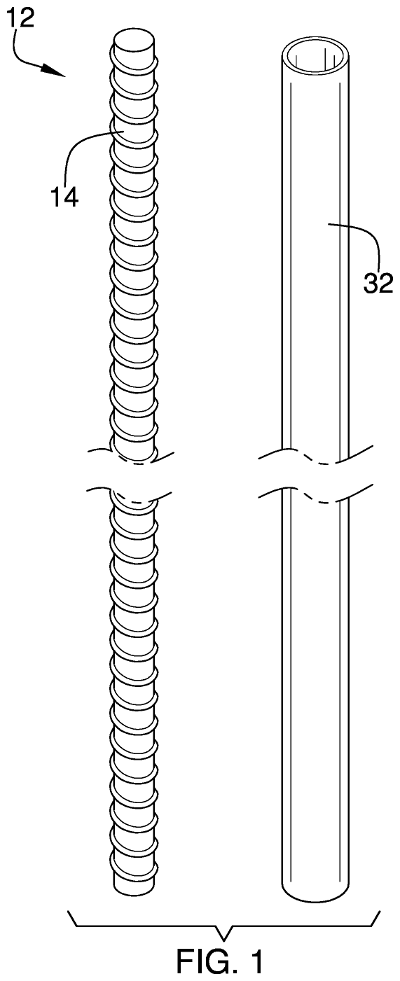

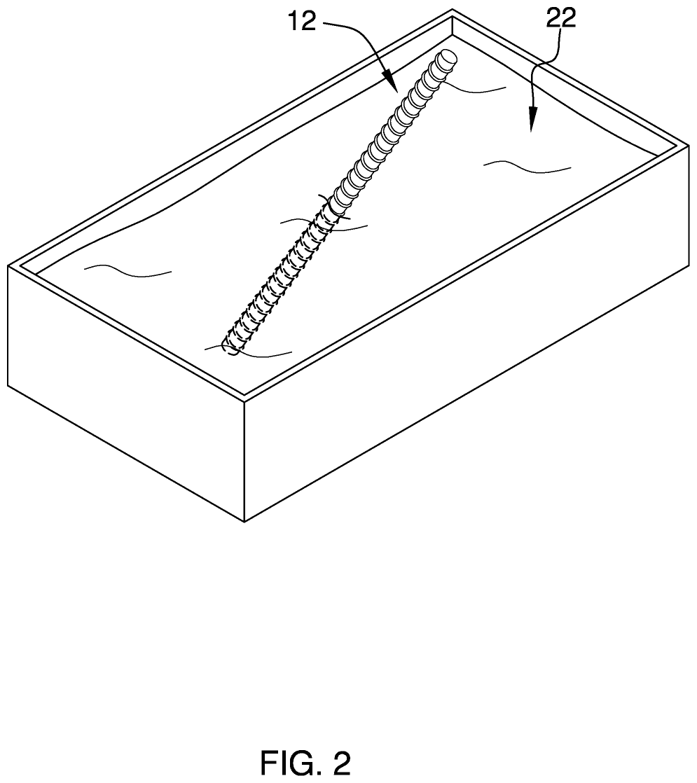

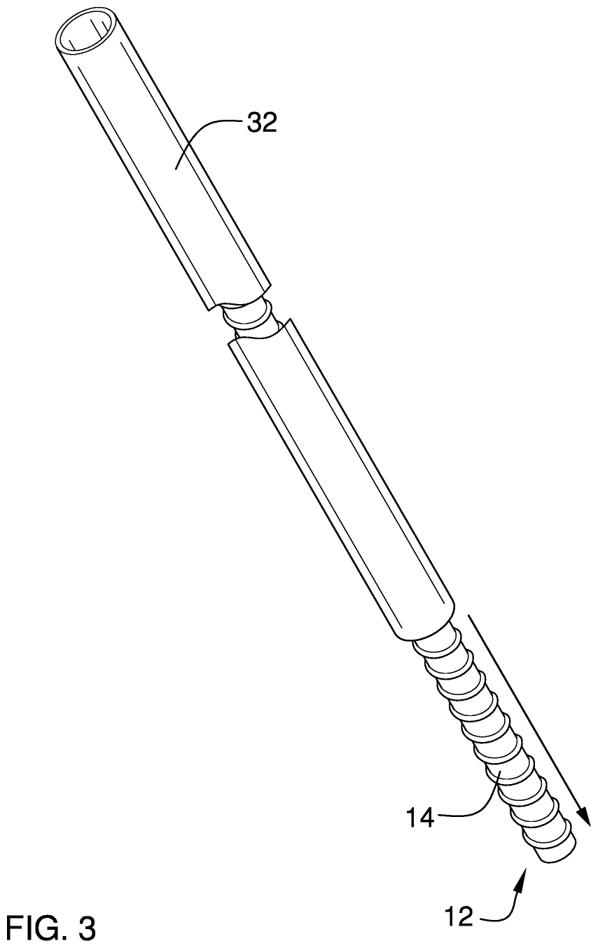

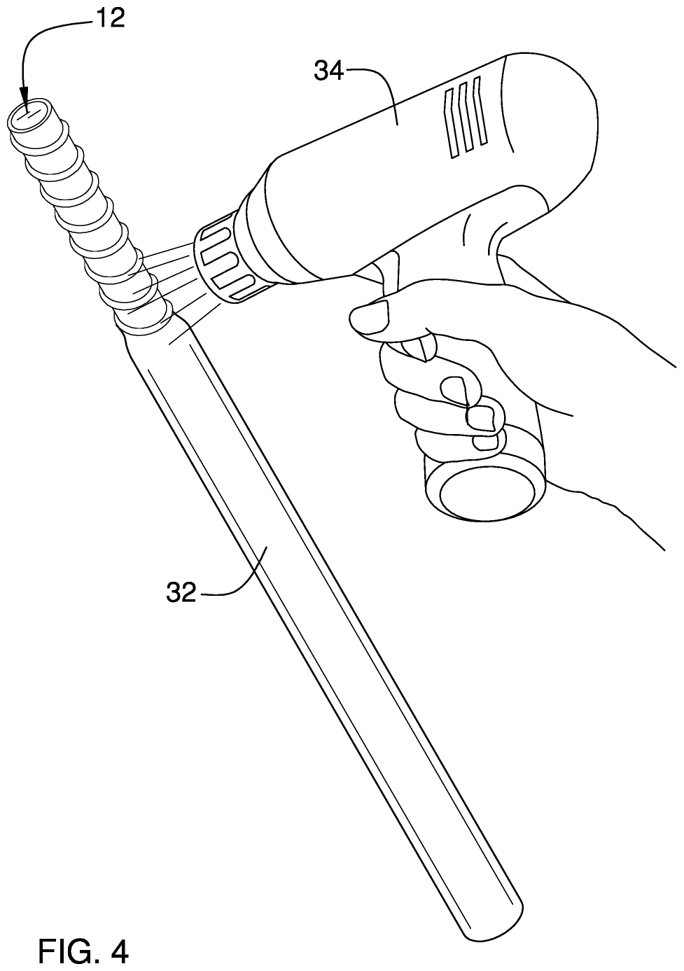

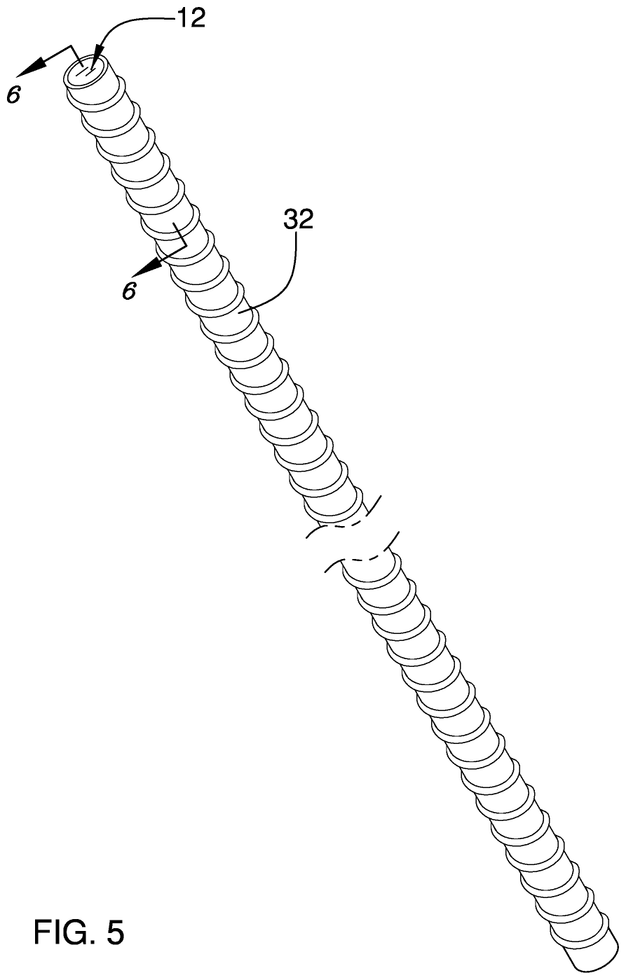

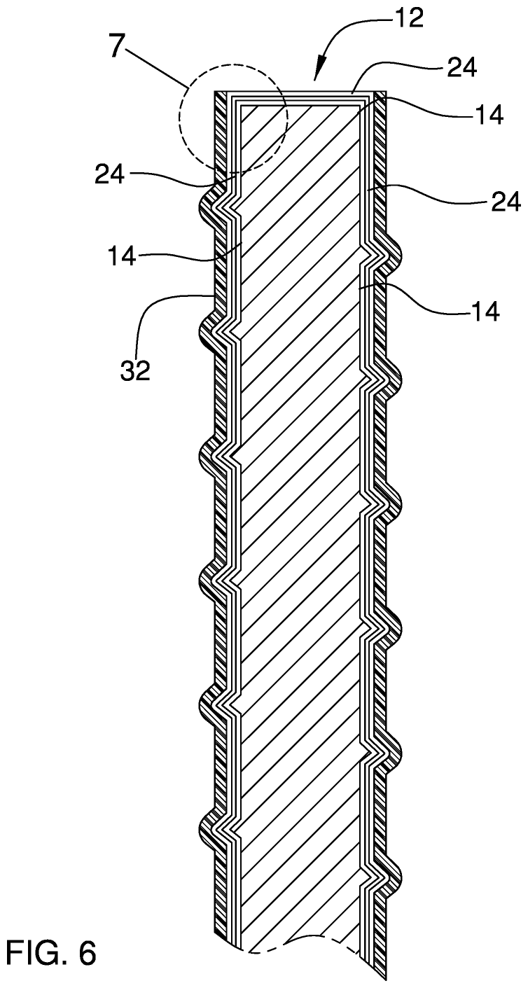

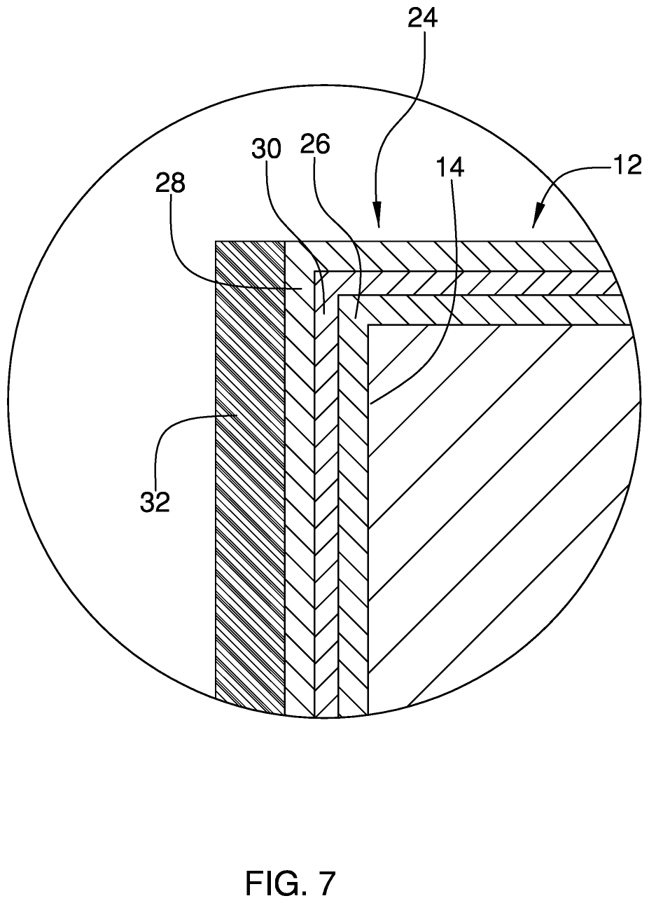

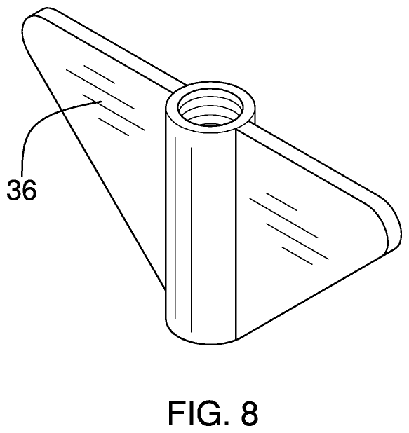

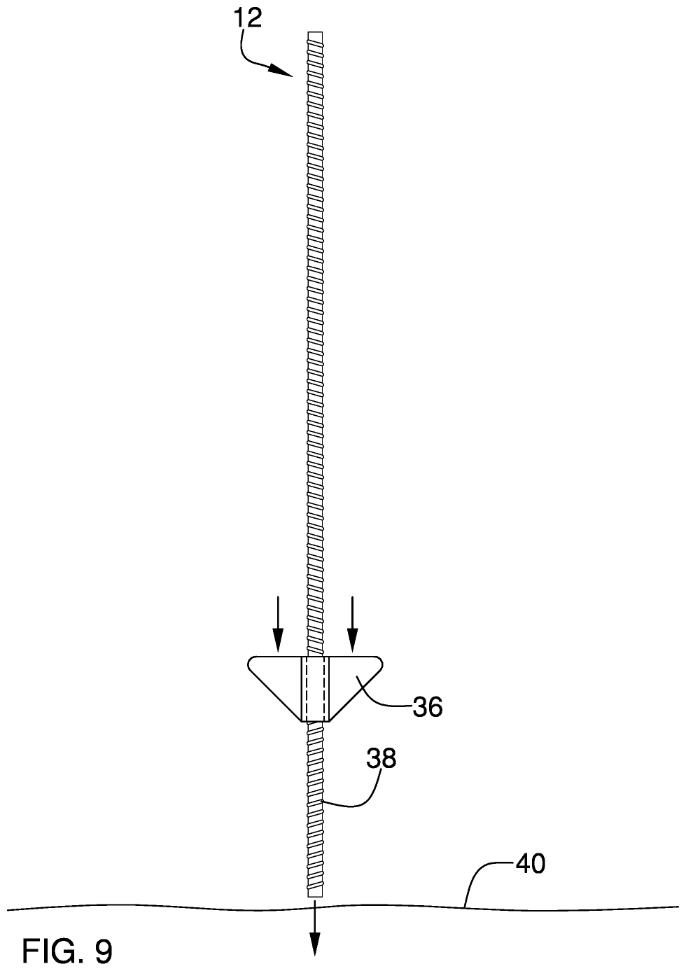

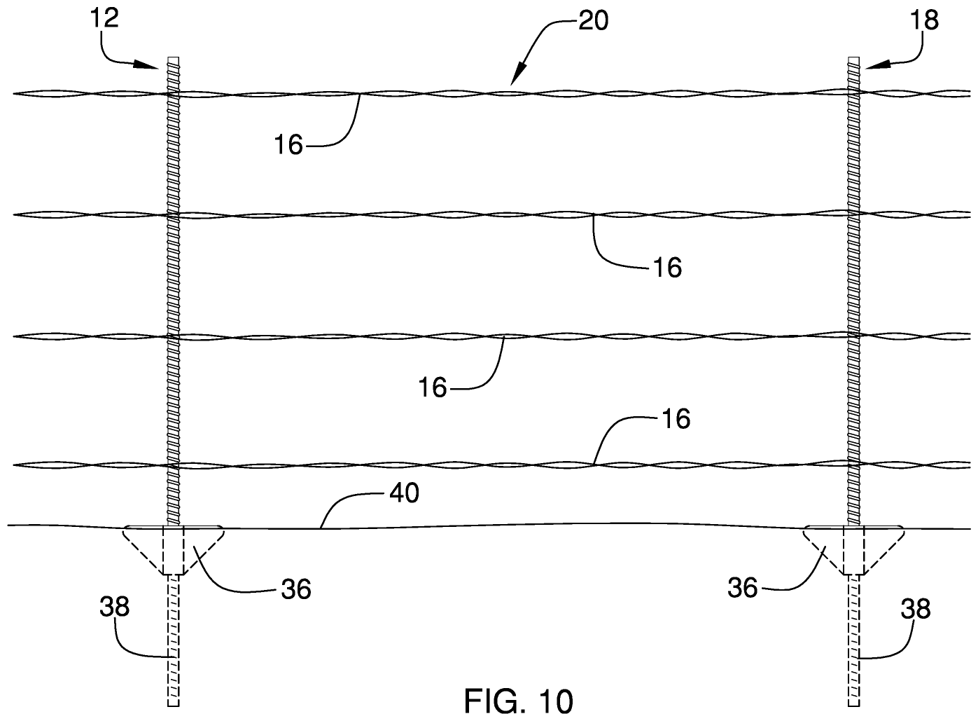

With reference now to the drawings, and in particular to FIGS. 1 through 10 thereof, a new method for preventing corrosion embodying the principles and concepts of an embodiment of the disclosure and generally designated by the reference numeral 10 will be described.

As best illustrated in FIGS. 1 through 10, the method for preventing corrosion to an iron alloy post 10 generally comprises a fence post 12 comprising an iron alloy material. The iron alloy material is configured to deteriorate over a period of time due to oxidation. The fence post 12 is typically a steel rebar, wherein an exterior surface 14 of the fence post 12 is threaded with male threads. Alternatively, the fence post 12 may be a T-post or any other conventional fence post 12. The fence post 12 attaches by lateral rails 16 to at least one other post 18 to form a fence line 20.

An anti-corrosion solution 22 may be applied to the fence post 12 and is configured to prevent corrosion to the fence post 12 due to oxidation. The anti-corrosion solution 22 typically comprises molten zinc, wherein the anti-corrosion solution 22 is configured to react with the exterior surface 14 of the fence post 12 to form a galvanized coat 24. The galvanized coat 24 is a zinc-iron alloy that covers the exterior surface 14 of the fence post 12. The fence post 12 is submerged into the anti-corrosion solution 22 and reacts with the anti-corrosion solution 22 over a time span typically from 4 minutes to 5 minutes. The galvanized coat 24 formed on the exterior surface 14 of the fence post 12 typically includes an inner layer 26 positioned adjacent to the exterior surface 14 of the fence post 12, an outer layer 28, and a center layer 30 positioned between the inner 26 and outer 28 layers. The inner layer 26 typically contains between 8% to 12% iron. The center layer 30 typically contains between 4% to 8% iron. The outer layer 28 typically contains 100% zinc. In one alternative, the anti-corrosion solution 22 may comprise a rust inhibitor paint that is typically applied on using a paint brush. In another embodiment, the anti-corrosion solution 22 may comprise tar, urethane, plastic blends, or any other anti-corrosive material.

An insulation sleeve 32 encloses the exterior surface 14 of the fence post 12. The insulation sleeve 32 comprises a heat shrink material, comprising a plastic material colloquially referred to as “shrink wrap.” The insulation sleeve 32 is heated to shrink and abut continuously against the exterior surface 14 of the fence post 12 such that the fence post 12 is sealed within the insulation sleeve 32. The insulation sleeve 32 may be heated by a heat emitter 34 such as a heated air blower. The insulation sleeve 32 facilitates preventing deterioration to the fence post 12 having the galvanized coat 24 thereon. In another embodiment, the insulation sleeve 32 may enclose the exterior surface 14 of the fence post 12 not having the galvanized coat 24 thereon. The insulation sleeve 32 may have a thickness typically between 0.5 mm and 3.0 mm after it has been heated forms a seal on the fence post 12.

A standing member 36 fastens to the fence post 12 and is positioned adjacent to a bottom end 38 of the fence post 12. The standing member 36 comprises a winged collar nut having female treads that threadedly engages with the male threads of the exterior surface 14 of the fence post 12. The bottom end 38 and the standing member 36 insert into a ground surface 40 to frictionally anchor the fence post 12 in ground surface 40. In another embodiment, the stand member is removed from the fence post 12 such that the bottom end 38 is inserted into the ground surface 40 to frictionally anchor the fence post 12 in the ground surface 40.

In use, the fence post 12 is coated with the anti-corrosion solution 22 configured to prevent corrosion to the fence post 12 due to oxidation. The fence post 12 extends into the insulation sleeve 32 such that the exterior surface 14 of the fence post 12 is completely enclosed within the insulation sleeve 32. The standing member 36 fastens to the fence post 12 and is positioned adjacent to the bottom end 38 of the fence post 12. The bottom end 38 and the standing member 36 insert into the ground surface 40 to frictionally anchor the fence post 12 in ground surface 40. The fence post 12 attaches by lateral rails 16 to at least one other post 18 to form the fence line 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method for preventing deterioration to fencing due to oxidation comprising the steps of:
coating a fence post with an anti-corrosion solution configured to prevent corrosion to said fence post due to oxidation;
extending the fence post into an insulation sleeve such that said exterior surface of said fence post is completely enclosed within the insulation sleeve;
fastening a standing member to said fence post and being positioned adjacent to a bottom end of the fence post; and
inserting said bottom end and said standing member into a ground surface to frictionally anchor said fence post in ground surface.

2. The method of claim 1, wherein the step of coating a fence post with an anti-corrosion solution configured to prevent corrosion to said fence post due to oxidation further includes said fence post comprising an iron alloy material and said anti-corrosion solution comprising molten zinc, wherein said anti-corrosion solution is configured to react with an exterior surface of said fence post to form a galvanized coat, said exterior surface of said fence post being threaded.

3. The method of claim 1, wherein the step of extending the fence post into an insulation sleeve such that said exterior surface of said fence post is completely enclosed within the insulation sleeve further includes said insulation sleeve comprising a heat shrink material, wherein said insulation sleeve is heated to shrink and abut continuously against said exterior surface of said fence post such that said fence post is sealed within said insulation sleeve.

4. The method of claim 1, wherein the step of fastening a standing member to said fence post and being positioned adjacent to a bottom end of the fence post further includes said standing member comprising a winged collar nut, said winged collar nut threadedly engaging with said exterior surface of said fence post.

5. A method for preventing deterioration to fencing due to oxidation comprising the steps of:
coating a fence post with an anti-corrosion solution configured to prevent corrosion to said fence post due to oxidation, said fence post comprising an iron alloy material and said anti-corrosion solution comprising molten zinc, wherein said anti-corrosion solution is configured to react with an exterior surface of said fence post to form a galvanized coat, said exterior surface of said fence post being threaded;
extending the fence post into an insulation sleeve such that said exterior surface of said fence post is completely enclosed within the insulation sleeve, said insulation sleeve comprising a heat shrink material, wherein said insulation sleeve is heated to shrink and abut continuously against said exterior surface of said fence post such that said fence post is sealed within said insulation sleeve;
fastening a standing member to said fence post and being positioned adjacent to a bottom end of the fence post, said standing member comprising a winged collar nut, said winged collar nut threadedly engaging with said exterior surface of said fence post; and
inserting said bottom end and said standing member into a ground surface to frictionally anchor said fence post in ground surface.

6. A method for preventing deterioration to fencing due to oxidation comprising the steps of:
extending a fence post into an insulation sleeve such that said exterior surface of said fence post is completely enclosed within the insulation sleeve, said insulation sleeve comprising a heat shrink material, wherein said insulation sleeve is heated to shrink and abut continuously against said exterior surface of said fence post such that said fence post is sealed within said insulation sleeve; and
fastening a standing member to said fence post and being positioned adjacent to a bottom end of the fence post, said standing member comprising a winged collar nut, said winged collar nut threadedly engaging with said exterior surface of said fence post; and
inserting said bottom end and said standing member into a ground surface to frictionally anchor said fence post in ground surface.
